(19) United States
(12) Patent Application Publication
(10) Pub. No.: US 2025/0008965 A1
(43) Pub. Date: Jan. 9, 2025

(54) leaf-shaped pastry sheet dough Composition with rolled-in margarine for baking and method of preparing chocolate pastry

(71) Applicant: LOTTE Wellfood Co., Ltd, Seoul (KR)

(72) Inventors: Soo Dong Shim, Seoul (KR); Hye Lim Jo, Seoul (KR); Maeng Soo Kang, Seoul (KR); Ho Yong Park, Seoul (KR); Won Joo Yoon, Seoul (KR); Gyeong Hweon Lee, Seoul (KR)

(73) Assignee: LOTTE Wellfood Co., Ltd, Seoul (KR)

(21) Appl. No.: 18/645,764

(22) Filed: Apr. 25, 2024

(30) Foreign Application Priority Data
Jul. 5, 2023 (KR) 10-2023-0087325

(51) Int. Cl. A21D 2/16; A21D 8/02; A21D 13/22; A21D 13/24; A21D 13/28

(52) U.S. Cl. CPC A21D 2/165; A21D 8/02; A21D 13/22; A21D 13/24; A21D 13/28

(57) ABSTRACT

Disclosed are a leaf-shaped pastry sheet dough composition with rolled-in margarine for baking and a method of preparing a chocolate pastry using the same. More specifically, the method includes rolling-in margarine with 0% butterfat to prepare pastry dough for baking, molding the dough into a predetermined leaf shape, topping the dough with a pre-mix of a maltose powder and powdered sugar at a ratio of 7:3 to impart exterior gloss to the baked pastry, baking the resulting dough, and coating the bottom of the baked pastry confectionery with tempered chocolate. This process was first attempted in the chocolate pastry confectionery with a long shelf life of one month or more in Korea.

### CROSS-REFERENCE TO RELATED APPLICATION

This application claims, under 35 U.S.C. § 119(a), the benefit of priority to Korean Patent Application No. 10-2023-0087325 filed on Jul. 5, 2023, the entire contents of which are incorporated herein by reference.

### BACKGROUND

### (a) Technical Field

The present disclosure relates to a leaf-shaped pastry composition applicable to baking and a method of preparing a chocolate pastry using the same.

### (b) Background Art

In general, confectionery pastries contain margarine for baking which contains about 5-10% less milk cream than regular butter in consideration of suitability for the forming process to create layers between dough sheets. On the other hand, the present disclosure provides a process of preparing leaf-shaped pastry dough sheets using margarine having no milk cream. The process according to the present disclosure is characterized in that factors affecting product quality when scrap accumulates during continuous production are minimized by reducing scrap generated during the process of forming characteristic continuous leaf-shaped patterns to less than 5%.

In addition, the process of the present disclosure further includes, after molding a dough in the form of a leaf shape, topping the dough with the pre-mix of minimally absorbed maltose powder and powdered sugar at a ratio of 7:3, to impart exterior gloss to the baked pastry. Generally, sugar syrup (40-65 Brix°) is sprayed as a gloss agent, but this has drawbacks in that the uniformity of dough expansion is low and moisture transfers from the sugar syrup to the pastry base. Therefore, the method according to the present disclosure can retain the shape of the pastry after baking and stably improve the unique texture by topping with raw materials having a low moisture content.

Meanwhile, pastries for baking with a short shelf life have a high dough moisture content, easy expression of taste, soft texture and rich flavors compared to pastries for confectionery. However, pastries for baking have limitations of mass production and distribution due to low thermal stability, storage, and long-term distribution safety for more than one month compared to pastries for confectionery.

Meanwhile, specific manufacturing equipment and processes or manufacturer's cumbersome work procedures are required to roll the margarine in confectionery/bread at a predetermined rate and to mold confectionery/bread into the desired shape in the process of manufacturing the confectionery/bread containing margarine using this pastry composition.

Therefore, regarding compositions and chocolate pastries formed by molding, into a leaf shape, pastry sheet dough with rolled-in margarine for baking, which strengthens the implementation of the pastry's unique texture and technically provides thermal stability and safety for storage and distribution, there is a need for products that are commercially satisfactory to consumers by increasing the convenience of rolling-in and molding during preparation of these compositions and chocolate pastries and ensuring distribution safety.

Tempered chocolate was added to the prepared pastry to impart luxurious chocolate flavor thereto, resulting in bottom half-enrobed chocolate pastries. This formulation was first attempted in mass-produced pastry with a long shelf life of one month or more in Korea. There are similar formulations in other nations, such as Japan, and in Europe.

The above information disclosed in this Background section is provided only for enhancement of understanding of the background of the invention, and therefore it may include information that does not form the prior art that is already known in this country to a person of ordinary skill in the art.

### SUMMARY OF THE DISCLOSURE

The present disclosure has been made in an effort to solve the above-described problems associated with the prior art.

It is an object of the present disclosure to provide a method of preparing a pastry composition and chocolate pastry with excellent shape and texture, more specifically, a method of preparing a pastry composition for baking and chocolate pastry with an excellent pastry unique flavor and texture of layers by molding a pastry sheet dough with rolled-in margarine into the form of a leaf.

The objects of the present disclosure are not limited to those described above. The objects of the present disclosure will be clearly understood from the following description, and are capable of being implemented by means defined in the claims and combinations thereof.

In one aspect, the present disclosure provides a chocolate pastry composition with excellent shape and texture containing 39 to 42% by weight of flour, 16 to 18% by weight of margarine (0% by weight of butterfat), 13 to 15% by weight of semi-chocolate (temper), 12 to 14% by weight of purified water, 8 to 10% by weight of sugar, 3 to 4% by weight of a combination of maltose powder and powdered sugar, 1.7 to 2.0% by weight of processed butter, 1.0 to 1.5% by weight of a combination of powdered milk and cinnamon powder, 0.1 to 0.2% by weight of a synthetic flavor, 0.1 to 0.2% by weight of salt, 0.02 to 0.05% by weight of an emulsifier, and 0.0007 to 0.001% by weight of a colorant, based on the total weight of the chocolate pastry composition.

In another aspect, the present disclosure provides a method of preparing the chocolate pastry composition including preparing pastry dough containing margarine, molding the dough into a leaf shape, topping the leaf-shaped dough with sugar and then a combination of a maltose powder and powdered sugar, and baking the resulting dough.

The method may further include adding tempered chocolate to the bottom of the pastry to impart a luxurious chocolate flavor to the baked pastry and thereby produce bottom half-enrobed chocolate pastries, wherein the semi-chocolate is present in an amount of 13 to 15% by weight, based on the total weight of the pastry composition.

Other aspects and preferred embodiments of the invention are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 shows a finished chocolate pastry according to one aspect of the present disclosure wherein the finished chocolate pastry has a configuration in which a pastry confectionery composition is contained in a chocolate pastry composition; and

FIG. 2 shows a process of preparing a chocolate pastry containing the pastry composition of the present disclosure.

### DETAILED DESCRIPTION

The objects described above, and other objects, features and advantages, will be clearly understood from the following preferred embodiments with reference to the annexed drawings. However, the present disclosure is not limited to the embodiments, and will be embodied in different forms. The embodiments are suggested only to offer thorough and complete understanding of the disclosed contents and to sufficiently inform those skilled in the art of the technical concept of the present disclosure.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures, among other things. For this reason, it should be understood that, in all cases, the term “about” should be understood to modify all numbers, figures and/or expressions. In addition, when numerical ranges are disclosed in the description, these ranges are continuous and include all numbers from the minimum to the maximum including the maximum within the ranges unless otherwise defined. Furthermore, when a range refers to integers, it includes all integers from the minimum to the maximum including the maximum within the range, unless otherwise defined.

It should be understood that, in the specification, when a range is referred to regarding a parameter, the parameter encompasses all figures including end points disclosed within the range. For example, the range of “5 to 10” includes figures of 5, 6, 7, 8, 9, and 10, as well as arbitrary sub-ranges, such as ranges of 6 to 10, 7 to 10, 6 to 9, and 7 to 9, and any figures, such as 5.5, 6.5, 7.5, 5.5 to 8.5 and 6.5 to 9, between appropriate integers that fall within the range. In addition, for example, the range of “10% to 30%” encompasses all integers that include numbers such as 10%, 11%, 12% and 13%, as well as 30%, and any sub-ranges, such as 10% to 15%, 12% to 18%, or 20% to 30%, as well as any numbers, such as 10.5%, 15.5% and 25.5%, between appropriate integers that fall within the range.

Hereinafter, the present disclosure will be described in detail.

The present disclosure provides a leaf-shaped pastry sheet dough composition with rolled-in margarine for baking and a method of preparing a chocolate pastry using the same.

More specifically, the pastry composition realizes a butter flavor and a characteristic texture based on 160 layers, and secures a level of heat resistance to be baked at a high temperature for a long time along with the pastry dough during preparation and thus imparts a sense of luxury to chocolate pastry confectionery based thereon by adding chocolate thereto.

Generally, in order to roll margarine in pastry dough, first, a mix of pastry dough and margarine is prepared, the dough and margarine are discharged (in 2 layers) using a co-extruder, the resulting dough is pressed with primary upper and lower rollers, the resulting dough is folded into 8 layers, the resulting dough is pressed with secondary upper and lower rollers, the resulting dough is folded into 10 layers, the resulting dough is pressed with tertiary and quaternary upper and lower rollers, and the dough is spread to a final thickness (3 mm or less). Then, the dough is molded into the desired shape, which is called “stamping”. At this time, the dough is stamped into a leaf shape, which is subjected to the subsequent process.

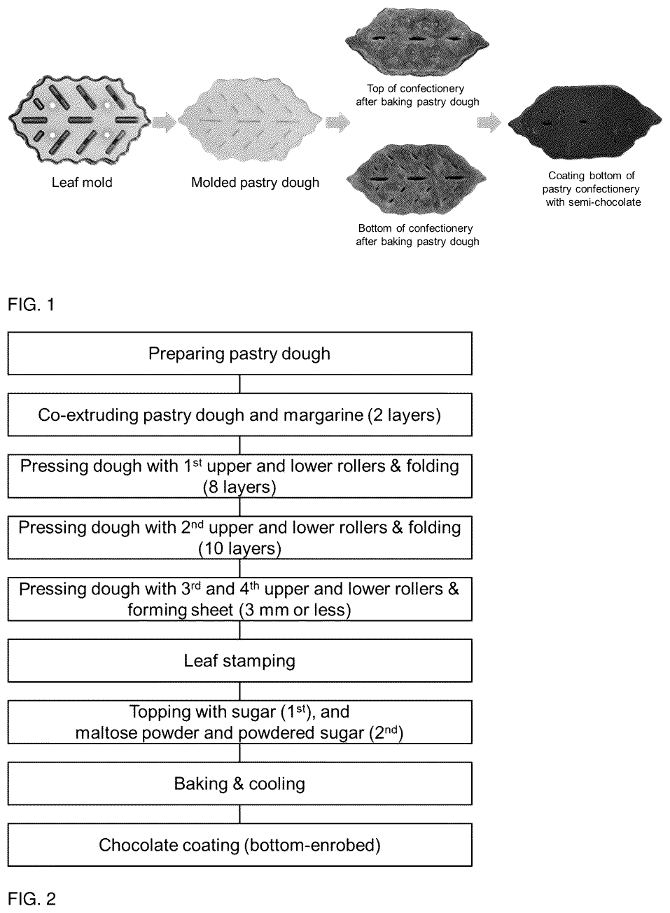

The attempt first made by the present disclosure distinguished from other pastries was to mold the dough into a differentiated shape (leaf) in the general process (FIG. 1). The top of the molded dough surface is topped with sugar (primary topping) and with a combination of a maltose powder and powdered sugar (secondary topping) to impart external gloss to the baked pastry. After baking, a finished product can be obtained, as shown in FIG. 1, immediately without any additional gloss-imparting process. The present disclosure is possible because the composition has sufficient heat resistance to allow margarine for baking to be rolled in the dough and gloss is imparted to the top of the dough surface before baking after stamping into a leaf shape.

Hereinafter, various aspects of the present disclosure are described.

The present disclosure relates to a composition prepared by molding pastry sheet dough with rolled-in margarine for baking into a leaf shape and a method of preparing a chocolate pastry using the same, wherein the composition contains 39 to 42% by weight of flour, 16 to 18% by weight of margarine (0% by weight of butterfat), 13 to 15% by weight of semi-chocolate (tempered), 12 to 14% by weight of purified water, 8 to 10% by weight of sugar, 3 to 4% by weight of a combination of maltose powder and powdered sugar, 1.7 to 2.0% by weight of processed butter, 1.0 to 1.5% by weight of a combination of powdered milk and cinnamon powder, 0.1 to 0.2% by weight of a synthetic flavor, 0.1 to 0.2% by weight of salt, 0.02 to 0.05% by weight of an emulsifier, and 0.0007 to 0.001% by weight of a colorant, based on the total weight of the chocolate pastry composition.

In one embodiment, the flour may include at least one of wheat flour or nutrient-enhanced flour.

In one embodiment, as the margarine, a liquid oil is more preferable than a general margarine, more specifically, than an oil with a high solid content that forms and changes oil crystals depending on temperature in terms of suitability for manufacture, but butter and processed butter may also be used depending on physical properties particularly required for molded final pastry dough. General margarine has a butterfat content of 5 to 10% by weight, whereas the margarine used in the present disclosure has a butterfat content of 0% by weight and thus can be used to produce pastries for baking.

In one embodiment, the purified water and sugar may contain at least one of sugar or other type of sugar.

In one embodiment, the composition may contain processed butter, powdered milk, cinnamon powder, synthetic flavoring, salt, and a colorant to impart the unique flavor and color to the pastry.

In one embodiment, the emulsifier may include at least one of glycerin fatty acid ester, succinic acid-monoglyceride, saturated acid monoglyceride, calcium stearoyl lactate, sodium stearoyl lactate, sugar ester, or lecithin. In one embodiment, the emulsifier may be present in an amount of 0.02 to 0.05% by weight.

In one embodiment, a total amount of the maltose powder and sugar should be limited to 3 to 4% by weight to impart gloss to baked pastries.

In one embodiment, the semi-chocolate is a composition containing 3 to 8% by weight of a cocoa mass, 20 to 35% by weight of sugar, and 25 to 38% by weight of fats and oils, and is subjected to tempering to stabilize oil crystals in the oil by controlling the temperature of the chocolate, thereby provide soft and luxurious chocolate flavor.

In another aspect, the present disclosure provides a method of preparing a chocolate pastry including preparing pastry dough containing margarine, molding the dough into a leaf shape, topping the leaf-shaped dough with sugar, and then a combination of a maltose powder and powdered sugar, baking the resulting dough, and adding tempered chocolate to the bottom of the pastry (bottom half-enrobed chocolate) to impart a luxurious chocolate flavor to the baked pastry.

In one embodiment, the method includes co-extruding the mixed pastry dough and margarine (in 2 layers) using a co-extruder, pressing the resulting dough with primary upper and lower rollers, folding the resulting dough into 8 layers, pressing the resulting dough with secondary upper and lower rollers, folding the resulting dough into 10 layers, pressing the resulting dough with tertiary and quaternary upper and lower rollers to form a total of 160 layers (2 layers×8 layers×10 layers) and thinly spreading the dough to a final thickness (3 mm or less).

In one embodiment, the method includes molding the dough into a leaf shape. (FIG. 2).

In one embodiment, the method includes topping the resulting dough with 3 to 4% by weight of a combination of maltose powder and powdered sugar.

In one embodiment, the method includes baking and passing the baked product through a tunnel oven using gas heat as a heat transfer medium for 15 to 18 minutes.

In one embodiment, the method includes adding tempering chocolate to the bottom of the pastry (bottom half-enrobed chocolate) and coating the bottom of the baked pastry with 13 to 15% by weight of semi-chocolate.

Hereinafter, the present disclosure will be described in more detail with reference to specific examples. However, the following examples are provided only for better understanding of the present disclosure, and thus should not be construed as limiting the scope of the present disclosure.

### Preparation of Chocolate Pastry Compositions: Chocolate Pastry Preparation Examples 1 to 6

The method of preparing the leaf-shaped pastry sheet dough composition with rolled-in margarine for baking and the method of preparing a chocolate pastry using the same according to the embodiment of the present disclosure include preparing a composition containing 39 to 42% by weight of flour, 16 to 18% by weight of margarine (0% by weight of butterfat), 13 to 15% by weight of semi-chocolate (tempered), 12 to 14% by weight of purified water, 8 to 10% by weight of sugar, 3 to 4% by weight of a combination of maltose powder and powdered sugar, 1.7 to 2.0% by weight of processed butter, 1.0 to 1.5% by weight of a combination of powdered milk powder and cinnamon powder, 0.1 to 0.2% by weight of a synthetic flavor, 0.1 to 0.2% by weight of salt, 0.02 to 0.05% by weight of an emulsifier, and 0.0007 to 0.001% by weight of a colorant, based on the total weight of the chocolate pastry composition.

The flour used herein was strong flour having a protein content of 10 to 13% and weak flour having a protein content of 7.5 to 9%. The margarine used herein contained 0% by weight of butterfat. The sugar used in the combination of purified water and the sugar was white sugar. The processed butter used herein was regular processed butter containing 30% by weight or more of butterfat. Skim milk and cinnamon powder were also used. The synthetic flavor used herein was a milk flavor and the salt used herein was refined salt. The colorant used herein was a palm-derived extract. The emulsifier used herein was lecithin and the maltose powder used herein was starch syrup supplemented with a food additive. The powdered sugar used herein was sugar mixed with 2 to 5% by weight of starch to prevent caking during storage at room temperature (1-35° C.). The semi-chocolate used a composition containing 3 to 8% by weight of cocoa mass, 20 to 35% by weight of sugar, and 25 to 38% by weight of fats and oils.

TABLE 1

| | Content (%) | | | | | |
|---|---|---|---|---|---|---|
| | Preparation | Preparation | Preparation | Preparation | Preparation | Preparation |
| Ingredients | Example 1 | Example 2 | Example 3 | Example 4 | Example 5 | Example 6 |
| Flour 1 (strong) | 31 | 31 | 32 | 32 | 33 | 33 |
| Flour 2 (weak) | 9 | 9 | 8 | 8 | 8 | 8 |
| Margarine | 16 | 16 | 17 | 17 | 18 | 18 |
| Purified water | 13 | 12.7 | 13 | 13 | 13.2 | 13.5 |
| Sugar | 9 | 9 | 9 | 9 | 8 | 8 |
| Processed butter | 1.7 | 1.8 | 1.8 | 1.9 | 1.85 | 1.77 |
| Milk powder + | 1 | 1.1 | 1.2 | 1.3 | 1.4 | 1.5 |
| cinnamon powder | | | | | | |
| Synthetic flavor | 0.2 | 0.2 | 0.2 | 0.1 | 0.1 | 0.1 |
| (milk) | | | | | | |
| Salt | 0.2 | 0.2 | 0.2 | 0.1 | 0.1 | 0.1 |
| Colorant | 0.001 | 0.0009 | 0.0008 | 0.0007 | 0.0007 | 0.0007 |
| Emulsifier | 0.05 | 0.04 | 0.03 | 0.03 | 0.02 | 0.0293 |
| Maltose powder | 2.7 | 2.8 | 2.6 | 2.6 | 2.35 | 2.05 |
| Powdered sugar | 1.149 | 1.1591 | 0.9692 | 0.9693 | 0.9793 | 0.95 |
| Semi-chocolate | 15 | 15 | 14 | 14 | 13 | 13 |
| Total | 100 | 100 | 100 | 100 | 100 | 100 |

### Experimental Example 1. Evaluation of Compositions of Chocolate Pastry Preparation Examples 1 to 6

The suitability, thermal stability, flavor, and texture of the chocolate pastry preparation examples 1 to 6 were evaluated in the following manner.

Margarine rolling-in suitability and leaf-shaped molding suitability for the process of forming pastry dough sheets were evaluated as preparation suitability, based on three grades.

Thermal stability was determined based on four grades by observing the mold shape of the pastry after baking in an oven at 190° C. for 16 minutes.

The flavor and texture were determined based on four grades by measuring the sensory properties (crispness, mouthfeel) of the prepared chocolate pastry.

The experimental results are as shown in Table 2 below.

TABLE 2

| | Preparation | Preparation | Preparation | Preparation | Preparation | Preparation |
|---|---|---|---|---|---|---|
| Item | Example 1 | Example 2 | Example 3 | Example 4 | Example 5 | Example 6 |
| Preparation suitability | ◯ | ⊚ | ⊚ | ⊚ | ⊚ | ◯ |
| (rolled-in) | | | | | | |
| Preparation suitability | X | ⊚ | ⊚ | ⊚ | Δ | ◯ |
| (forming & molding) | | | | | | |
| Thermal stability (baking) | Δ | Δ | ⊚ | ◯ | ◯ | Δ |
| Flavor and texture | Δ | ◯ | ⊚ | ⊚ | ◯ | ◯ |

X: Very bad,
Δ: Bad,
◯: Good,
⊚: Very good

In Preparation Example 1, after preparation, the dough was excessively softened and the thermal stability was thus deteriorated.

In Preparation Example 2, the composition had excellent preparation suitability, but poor thermal stability.

In Preparation Example 5, the composition had a strong oily texture, readily caused phase transition during preparation and exhibited excellent thermal stability, but poor preparation suitability.

In Preparation Example 6, the composition had a similar texture to Preparation Example 5 and exhibited good preparation suitability, but had poor thermal stability.

It was finally found that the chocolate pastry compositions of Preparation Example 3 and Preparation Example 4 exhibited excellent preparation suitability, thermal stability, and good flavor and texture.

As is apparent from the foregoing, the pastry composition according to the present disclosure realizes a butter flavor and a characteristic texture based on 160 layers, and secures a level of heat resistance to be baked at a high temperature for a long time along with the pastry dough during preparation and thus imparts a sense of luxury to chocolate pastry confectionery based thereon by adding chocolate thereto. Mass production is possible reproducibly using automated preparation processes at industrial sites and distribution safety for a long period of time of one month or more can be improved, thus providing food products that can meet the needs of suppliers and satisfy consumers who demand excellent quality.

The effects of the present disclosure are not limited to those mentioned above. It should be understood that the effects of the present disclosure include all effects that can be inferred from the foregoing description of the present disclosure.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A pastry composition comprising a margarine rolled in, wherein the margarine is capable of baking, and the margarine comprises butterfat-free margarine.

2. The pastry composition according to claim 1, comprising:
39 to 42% by weight of a flour;
16 to 18% by weight of the margarine;
12 to 14% by weight of a purified water;
8 to 10% by weight of a sugar;
3 to 4% by weight of a combination of a maltose powder and a powdered sugar;
1.7 to 2.0% by weight of a processed butter;
1.0 to 1.5% by weight of a combination of a powdered milk and a cinnamon powder;
0.1 to 0.2% by weight of a synthetic flavor;
0.1 to 0.2% by weight of a salt;
0.02 to 0.05% by weight of an emulsifier; and
0.0007 to 0.001% by weight of a colorant, based on a total weight of the pastry composition,
wherein the pastry composition has a butterfat content of 0%.

3. The pastry composition according to claim 1, further comprising:
13 to 15% by weight of semi-chocolate, based on the total weight of the composition.

4. A method of producing a pastry, the method comprising:
preparing a pastry composition comprising a flour, a margarine, a purified water, a processed butter, a powdered milk, a cinnamon powder, a synthetic flavoring, a salt, a colorant, and an emulsifier;
molding the pastry composition into a leaf shape to obtain a leaf shaped dough;
topping the leaf-shaped dough with a sugar, maltose powder, and powdered sugar to obtain a resulting dough;
baking the resulting dough to obtain a baked pastry confectionery; and
adding tempered chocolate to a bottom of the baked pastry confectionery,
wherein the margarine is rolled in the pastry composition, wherein the margarine is capable of baking, and the margarine comprises butterfat-free margarine.

5. The method according to claim 4, further comprising:
pre-mixing the maltose powder and the powdered sugar at a ratio of 5:5 to 9:1, to impart exterior gloss to the pastry.

6. The method according to claim 4, wherein the pastry comprises:
39 to 42% by weight of the flour;
16 to 18% by weight of the margarine;
12 to 14% by weight of the purified water;
8 to 10% by weight of the sugar;
3 to 4% by weight of a combination of the maltose powder and the powdered sugar;
1.7 to 2.0% by weight of the processed butter;
1.0 to 1.5% by weight of a combination of the milk powder and the cinnamon powder;
0.1 to 0.2% by weight of the synthetic flavor;
0.1 to 0.2% by weight of the salt;
0.02 to 0.05% by weight of the emulsifier; and
0.0007 to 0.001% by weight of the colorant, based on a total weight of the pastry composition.
